(19) United States
(12) Patent Application Publication
(10) Pub. No.: US 2013/0308174 A1
(43) Pub. Date: Nov. 21, 2013

(54) OPTICAL MODULE FOR LASER BEAM SCAN

(71) Applicants: Pil-Kyu KIM, Yongin-City (KR); Gyoo-Wan HAN, Yongin-City (KR); Je-Kil RYU, Yongin-City (KR); Tae-Yong KIM, Yongin-City (KR); Seok-Hwan KIM, Yongin-City (KR); Sung-Gon KIM, Yongin-City (KR)

(72) Inventors: Pil-Kyu KIM, Yongin-City (KR); Gyoo-Wan HAN, Yongin-City (KR); Je-Kil RYU, Yongin-City (KR); Tae-Yong KIM, Yongin-City (KR); Seok-Hwan KIM, Yongin-City (KR); Sung-Gon KIM, Yongin-City (KR)

(21) Appl. No.: 13/767,046

(22) Filed: Feb. 14, 2013

(30) Foreign Application Priority Data
May 16, 2012 (KR) 10-2012-0052142

(51) Int. Cl. G02B 26/08

(52) U.S. Cl. CPC G02B 26/0816
USPC 359/226.1

(57) ABSTRACT

An optical module for irradiation of laser beams includes a mirror mount, a rotation shaft coupled to a center of the mirror mount, a vibration member coupled to one end of the mirror mount and the vibration member vibrating the end of the mirror mount in front-and-rear directions, a mirror fixed to the mirror mount and the mirror irradiating laser beams by performing reciprocal rotational motion with the mirror mount with respect to the rotation shaft, and a weight arranged on at least one of a first side and a second side of the mirror mount. The weight is interposed between the rotation shaft and the at least one of the first side and the second side to compensate concentricity of the mirror.

### CROSS-REFERENCE TO RELATED APPLICATION

This application claims priority under 35 U.S.C. §119 to Korean Patent Application No. 10-2012-0052142, filed in the Korean Intellectual Property Office on May 16, 2012, the entire contents of which are incorporated herein by reference.

### BACKGROUND

A laser may be utilized in several industry fields. For example, polysilicon used in a thin film transistor may be formed through a method using a laser. Further, the laser may be used in devices such as a laser beam printer, a scanner, and a projector.

### SUMMARY

An optical module for irradiation of laser beam according to an exemplary embodiment includes a mirror mount, a rotation shaft coupled to a center of the mirror mount, a vibration member coupled to one end of the mirror mount to vibrate the end of the mirror mount to front-and-rear direction, a mirror fixed to the mirror mount, and irradiating laser beam by performing reciprocal rotational motion with the mirror mount with respect to the rotation shaft, and a weight disposed at least one location between a first side and a second side on the mirror mount, disposed interposing the rotation shaft to compensate concentricity of the mirror.

The weight may be disposed in the first side on the mirror mount. The weight may include a first weight and a second weight respectively disposed in the first side and the second side on the mirror mount. The first weight and the second weight may have different weights.

Bolts may be fixed to the first side and the second side of the mirror mount and the weight may be formed as nuts fastened to the bolts. The weight may include a third weight and a fourth weight respectively disposed in the first side and the second side of the mirror mount and having different weights.

The weight may include a third weight and a fourth weight respectively disposed in the first side and the second side of the mirror mount, and the third weight and the fourth weight may have the same weight but have different distances with the mirror mount, respectively.

The weight may be provided in plural along a width direction of the mirror mount in at least one of the first side and the second side on the mirror mount. The weight may include a fifth weight and a sixth weight having different distances with the mirror

The fifth weight and the sixth weight may have different weights. The mirror may be tilted with respect to an installation direction of the rotation shaft.

The mirror mount may include an inner mount fixing the mirror and tilted with respect to the installation direction of the rotation shaft and an outer mount coupled to the rotation shaft and the vibration member while surrounding sides of the inner mount, excluding a side to which the mirror is fixed.

The outer mount may include an upper side, and the first side and the second side on the mirror mount may be a left-side end and a right-side end of the upper side.

### BRIEF DESCRIPTION OF THE DRAWINGS

FIG. 1 is a perspective view of an optical module for laser beam irradiation according to an exemplary embodiment.

FIG. 2 is a perspective view of a mirror mount of the optical module of FIG. 1.

FIG. 3 is a cross-sectional view of the optical module of FIG. 1, taken along the line I-I.

FIG. 4 is a schematic diagram for description of a function of a mirror in the optical module of FIG. 1.

FIG. 5 is a perspective view of a first exemplary variation of the mirror mount and a weight of FIG. 2.

FIG. 6A is a perspective view of a second exemplary variation of the mirror mount and the weight of FIG. 2.

FIG. 6B is a top plan view of the weight of FIG. 6A.

FIG. 7 is a perspective view of a third exemplary variation of the mirror mount and the weight of FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Like reference numerals refer to like elements throughout.

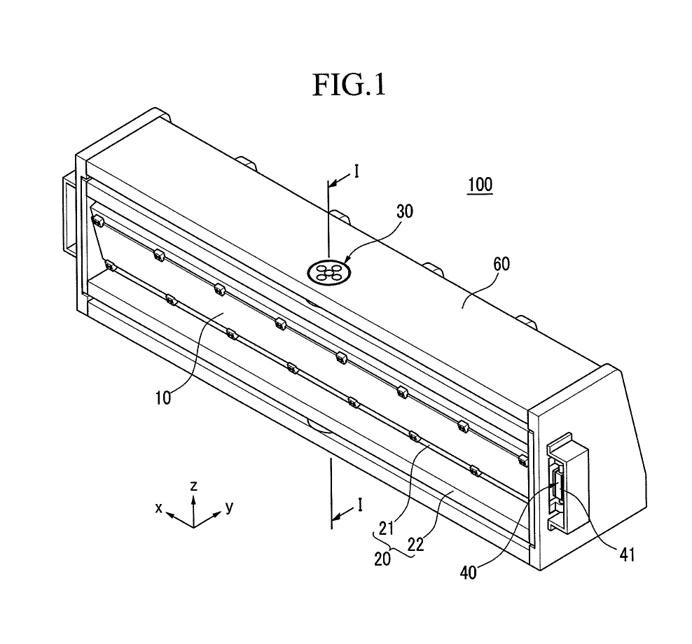

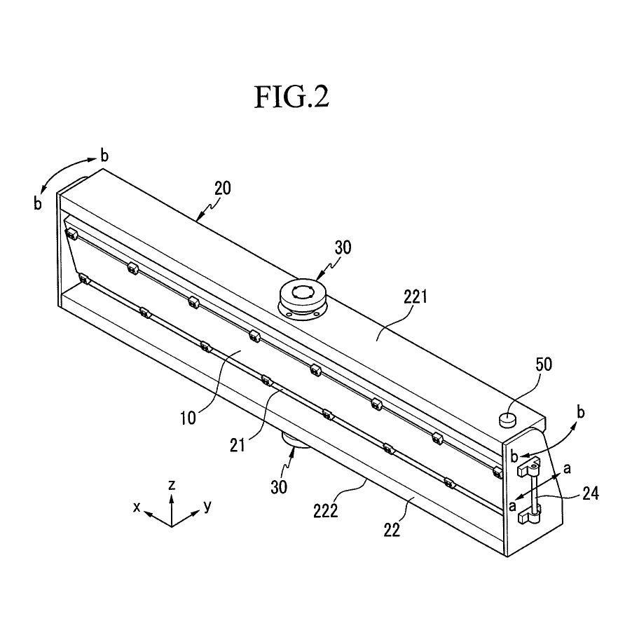

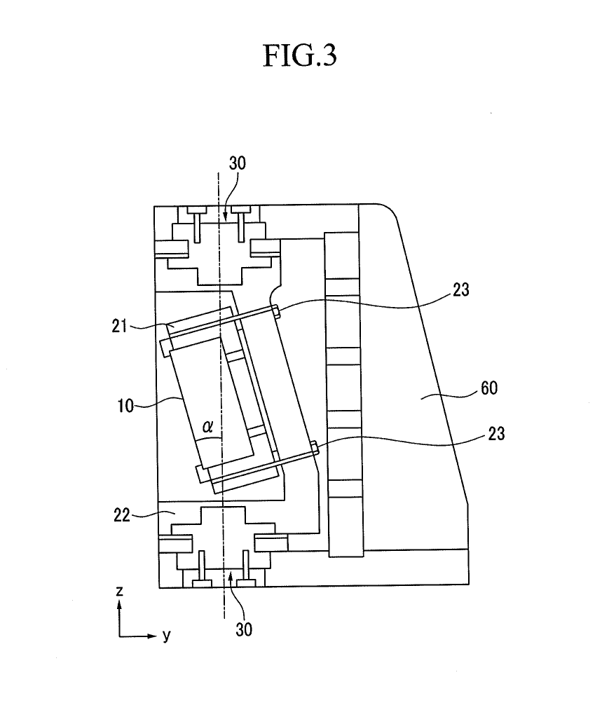

FIG. 1 is a perspective view of a optical module for laser beam irradiation (hereinafter, referred to as an optical module for convenience), FIG. 2 is a perspective view of a mirror mount of the optical module of FIG. 1, and FIG. 3 is a cross-sectional view of the optical module of FIG. 1, taken along the line I-I.

Referring to FIG. 1 to FIG. 3, an optical module 100 includes a mirror 10 and a mirror mount 20 supporting the mirror 10, e.g., in a fixed manner. The optical module 100 further includes a rotation shaft 30 coupled with the mirror mount 20 in a center region, e.g., at a center, thereof and a vibration member 40 coupled with one end of the mirror mount 20. The optical module 100 includes at least one weight 50 (refer to FIG. 2). The weight 50 may maintain rotational balance of the mirror 10 by compensating concentricity of the mirror 10, e.g., to reduce the possibility of and/or prevent misalignment of a laser beam with respect to the mirror 10.

The mirror 10 may be formed of a rectangular mirror having a predetermined length and a predetermined width. A length direction of the mirror 10 may be parallel with a horizontal direction (i.e., x-axis direction) and a width direction of the mirror 10 may be parallel with a height direction (i.e., z-axis direction).

Along the width direction, the mirror 10 may be tilted with a predetermined angle with respect the height direction (i.e., z-axis direction) for alignment with an emission optical system (not shown) that emits laser beams and a target (not shown) of laser beam irradiation. In FIG. 3, the tilt angle of the mirror 10 with respect to the height direction (z-axis direction) is denoted as a. For example, the tilt angle may be measured with respect to a front side of the mirror 10 and the z-axis direction.

The mirror mount 20 may be formed of an inner mount 21 fixed to the mirror 10 and an outer mount 22 surrounding the inner mount 21. The outer mount 22 may be coupled to the rotation shaft 30. In addition, the optical module 100 may include a housing 60 surrounding the mirror mount 20.

The inner mount 21 may be integrally coupled to the outer mount 22 by a coupling member such as a control bolt 23 (refer to FIG. 3). In addition, the inner mount 21 is tilted with a predetermined angle with respect to the height direction (i.e., z-axis direction) such that the mirror 10 can have the tilt angle of α. The outer mount 22 may be formed to surround upper, lower, and rear portions of the inner mount 21.

The rotation shaft 30 is coupled as a pair to an upper side 221 and a lower side 222 of the outer mount 22, e.g., at a center of the mirror mount 20. The pair of rotation shafts 300 is located in the same position along the height direction (i.e., z-axis direction). The rotation shaft 30 may be formed of a rotatable cross roller ring of which an inner space is coupled to the outer mount 22 and then rotates.

The vibration member 40 is coupled to one end of the mirror mount 20 to vibrate the end of the mirror mount 20 to a front-and-rear direction (i.e., a-a arrow direction in FIG. 2). Thus, the mirror mount 20 and the mirror 10 mounted thereto performs a reciprocating rotational motion with respect to the rotation shaft 30. In FIG. 2, the arrow b-b denotes a rotation direction of the mirror mount 20.

The vibration member 40 may be formed of a machine such as a motor or a piezo operator. FIG. 1 and FIG. 2 exemplarily illustrate that a shaft 24 is provided in one end of the mirror mount 20, and a piezo operator 41 that vibrates the shaft 24 in the front-and-rear direction is coupled to the shaft 24. The structure of the mirror mount 20 and the structure of the vibration member 40 are not limited to the illustrated structures.

In addition, the mirror mount 20 is exemplarily formed of the inner mount 21 and the outer mount 22, but the structure of the mirror mount 20 is not limited thereto. For example, the mirror mount 20 may be substantially formed in the shape of a rectangular parallelepiped extended in the horizontal direction (i.e., x-axis direction). In addition, a front side of the mirror mount 20, to which the mirror 10 is mounted, is formed as a tilted side so that the mirror 10 has a tilt angle of α.

In the present exemplary embodiment, any configuration of the rotation shaft 30, and the vibration member 40 that can perform respective functions is applicable to the optical module 100. For example, the function of the mirror mount 20 is to fix the mirror, the rotation shaft 30 is to support rotation of the mirror mount 20, and the function of the vibration member 40 is to vibrate the end of the mirror mount 20 to the front-and rear directions.

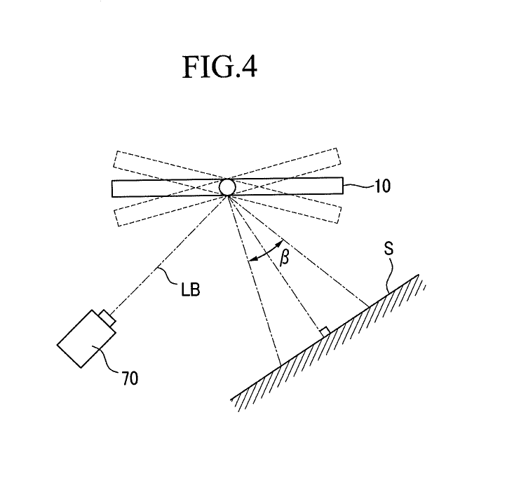

FIG. 4 is a schematic diagram for description of a function of the mirror in the optical module of FIG. 1.

Referring to FIG. 4, an emission optical system 70 that emits laser beam LB is disposed in front of the mirror 10. The emission optical system 70 may include a light source emitting the laser beam LB, a plurality of lenses, an optical modulator, and the like. The plurality of lenses and the optical modulator may function to control a path and density of the laser beam LB.

The mirror 10 performs a reciprocating rotational motion within an irradiation angle range of β of the laser beam LB by the vibration member 40. Thus, the mirror 10 irradiates the laser beam LB on a substrate S by reflecting the received laser beam LB. The substrate S may be a substrate where an amorphous silicon layer is formed, and may be replaced with a screen that displays an image by receiving the laser beam.

Referring back to FIG. 2, the mirror 10 and the mirror mount 20 may experience concentricity during high-speed reciprocating rotational motion.

For example, the mirror 10 and the mirror mount 20 may respectively have deviation in left and right weights due to a process error from a manufacturing process of the optical module 100. In addition, the mass center is changed according to the tilt angle of the mirror 10 and the inner mount 21, and accordingly concentricity and/or misalignment may occur. Further, during the high-speed rotation of the mirror 10 and the mirror mount 20, yawing and/or twisting may occur so that lateral ends of the mirror 10 and the mirror mount 20 may be shaken up and down.

The concentricity, misalignment, yawing, twisting, vibration, etc., of the mirror 10 and the mirror mount 20 may interrupt the rotational balance of the mirror 10. The optical module 100 may accordingly provide compensation to reduce the possibility of interrupted rotational balance and to suppress vibration by providing at least one weight 50 in the mirror mount 20. Accordingly rotational balance of the mirror 10 may be maintained.

In further detail, the weight 50 is disposed at least on one of a first side and a second side with respect to the mirror mount 20. The weight 50 may be disposed such that the rotation shaft 30 is interposed between the weight 50 and an adjacent one of the first side and the second side. With reference to FIG. 2, the first side and the second side with respect to the mirror mount 20 may be the mirror mount 20, that is, a left-side end and a right-side end of the upper side of the outer mount 22 may correspond to regions where the weight 50 may be arranged.

One weight 50 may be fixed to one of the left-side end and the right-side end of the mirror mount 20, based on the compensation of concentricity. FIG. 2 exemplarily illustrates that the weight 50 is fixed to the right-side end of the mirror mount 20, but the location of the weight 50 is not limited thereto. The weight and the fixing location of the weight 50 may be variously changed according to a degree of concentricity of the mirror 10 and the mirror mount 20.

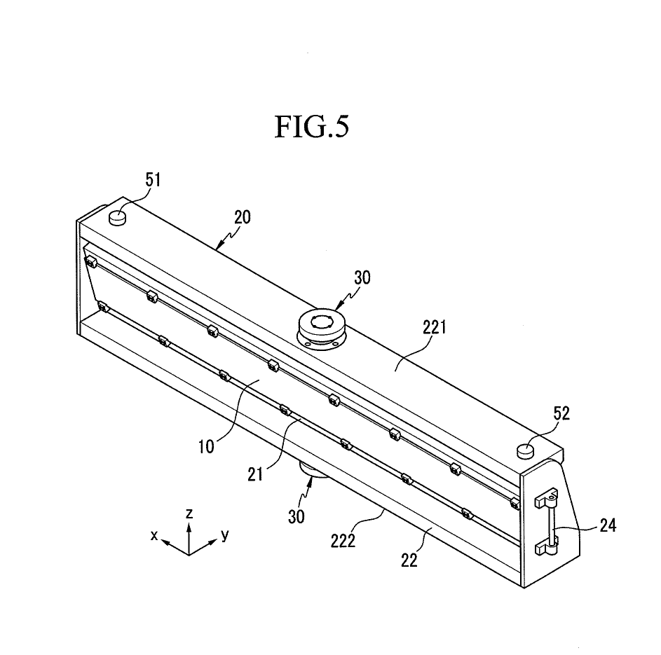

FIG. 5 is a perspective view of a first exemplary variation of the mirror mount and the weight of FIG. 2.

Referring to FIG. 5, weights 51 and 52 may be fixed to the left-end side and the right-side end, respectively, of the mirror mount 20. In this case, the first weight 51 fixed to the left-side end of the mirror mount 20 and the second weight 52 fixed to the right-side end of the mirror mount 20 have different weights. The weight difference and fixing locations of the first and second weights 51 and 52 may be variously set according to a degree of concentricity of the mirror 10 and the mirror mount 20.

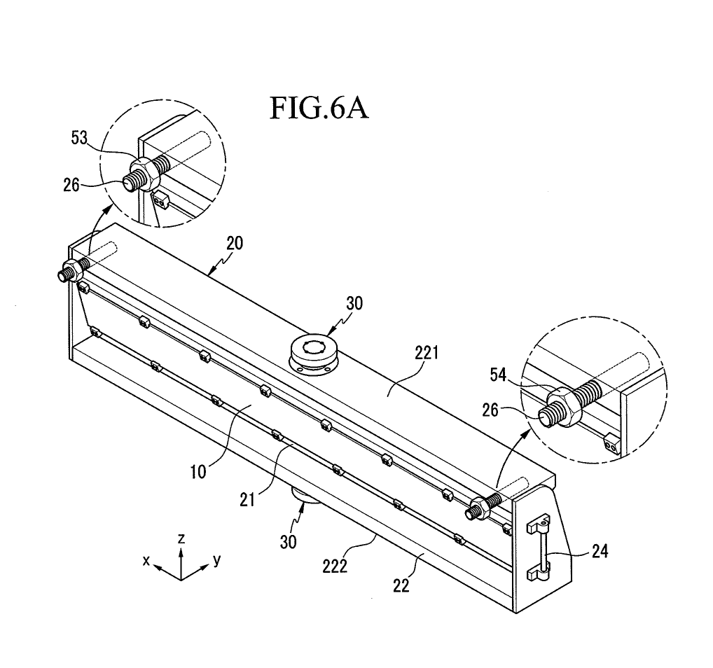

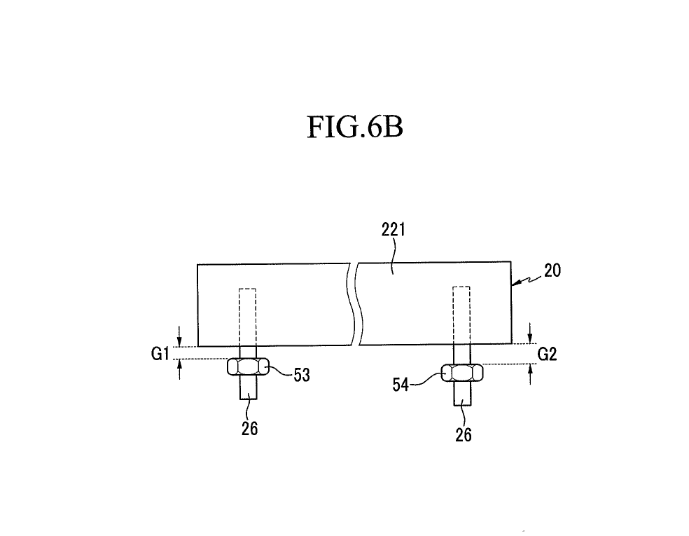

FIG. 6A is a perspective view of a second exemplary variation of the mirror mount and the weight of FIG. 2, and FIG. 6B is a partial top plan view of the weight of FIG. 6A.

Referring to FIG. 6A and FIG. 6B, the mirror mount 20 includes bolts 26 fixed to the left-side end and the right-side end of thereof, and weights 53 and 54 are formed of nuts fastened to the bolts 26. The bolts 26 are mounted in a fixed manner to an outer mount 22 along a parallel direction with an upper side of the outer mount 22. The third weight 53 fixed to the left-side end of the mirror mount 20 and the fourth weight 54 fixed to the right-side end of the mirror mount 20 may have different weights.

Alternatively, the third weight 53 and the fourth weight 54 have the same weight, but a distance between the third weight 53 and the mirror mount 20 and a distance between the fourth weight 54 and the mirror mount 20 may be different from each other. The third and fourth weights 53 and 54 can change their weight applied to the mirror mount 20 according to the distance with the mirror mount 20, and therefore the influences of the third and fourth weights 53 and 54 that have the same weight may be substantially the same as the influence of weights when each has a different weight.

FIG. 6A and FIG. 6B exemplarily illustrate that the third weight 53 and the fourth weight 54 have the same weight, while having different distances from the mirror mount 20, respectively. In FIG. 6B, a distance between the third weight 53 and the mirror mount 20 is denoted as G1, and a distance between the mirror mount 20 and the fourth weight 54 is denoted as G2.

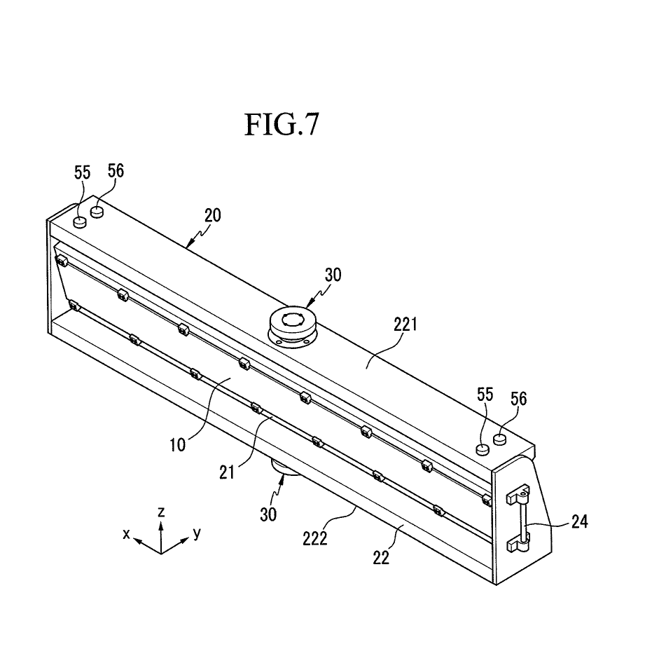

FIG. 7 is a perspective view of a third exemplary variation of the mirror mount and the weight of FIG. 2.

Referring to FIG. 7, the mirror 10 and the mirror mount 20 are tilted by an angle of α with respect to a height direction (i.e., z-axis direction) where the rotation shaft 30 is located, and therefore the mirror 10 and the mirror mount 20 may be wholly vibrated up and down during a high-speed reciprocal rotational motion.

In the third exemplary variation, weights 55 and 56 are provided in plural along a width direction (i.e., y-axis direction) of the mirror mount 20 in one of the left-side end and the right-side end. FIG. 7 exemplarily illustrates that two weights 55 and 56 are respectively provided in the left-side end and the right-side end of the mirror mount 20, but the number of weights 55 and 56 are not limited thereto.

The plurality of weights 55 and 56 provided along the width direction (y-axis direction) of the mirror mount 20, respectively, may have different weights. For example, the fifth weight 55 disposed close to the mirror 10 and the weight 56 disposed away from the mirror 10 have different weights. The weight difference and fixing locations of the fifth and sixth weights 55 and 56 may be variously changed according to, e.g., a degree of concentricity of the mirror 10 and the mirror mount 20.

In the first to third exemplary variations, the left-side end and the right-side end where the weights 51, 52, 53, 54, 55, and 56 on the mirror mount 20 respectively have may be arranged to have a same distance with respect to the rotation shaft 30.

As described, the optical module 100 according to the present exemplary embodiment can compensate for concentricity of the mirror 10 and the mirror mount 20 using the weights 50, 51, 52, 53, 54, 55, and 56. Accordingly, the optical module 100 can accurately irradiate laser beam while maintaining rotational balance of the mirror 10. The optical module 100 may be applied to a crystallization device of an amorphous silicon layer, and in this case, product quality of a polysilicon layer can be enhanced.

By way of summation and review, a laser has various uses. For example, polysilicon used in a thin film transistor of a liquid crystal display (LCD) or an organic light emitting diode (OLED) display can be formed through an annealing method using a laser. In addition, the laser may be used in other types of devices such as in a laser beam printer, a scanner, and a projector.

An optical module for irradiation of laser beam includes a mirror and a mirror mount. The mirror receives a laser beam emitted from a light source and irradiates the laser beam, and the mirror mount supports the mirror. A rotation shaft may be provided at a center or at one end of the mirror mount, and a vibration device may be provided at an opposite end of the mirror mount. In this case, the mirror performs a reciprocal rotational motion with respect to the rotation shaft while the end of the mirror, connected with the vibration device vibrates.

The optical module vibrates the mirror using a mechanical vibration device such as a motor or a Piezo operator, and irradiates the laser beam using vibration of the mirror. However, such a mechanical method may lead to concentricity and/or misalignment of the mirror, which may deteriorate rotational balance of the mirror. When the mirror cannot maintain rotational balance, the laser beam may not be accurately irradiated without rearranging the laser beam.

In contrast, embodiments relate to an optical module for irradiation of a laser beam and to an optical module that can compensate for concentricity and/or misalignment of a mirror. Further, embodiments relate to an optical module for irradiation of laser beam in which rotational balance of a mirror is maintained, e.g., by compensating concentricity of the mirror for accurate irradiation of laser beam.

For example, embodiments relate to an optical module that can compensate for concentricity of the mirror and the mirror mount by using a weight. Accordingly, the optical module can accurately irradiate laser beam by maintaining rotational balance of the mirror. The optical module may be applied to a crystallization device of an amorphous silicon layer, and in this case, a product quality of a polysilicon layer may be enhanced.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An optical module for irradiation of laser beams, the optical module comprising:
a mirror mount;
a rotation shaft coupled to a center of the mirror mount;
a vibration member coupled to one end of the mirror mount, the vibration member vibrating the end of the mirror mount in front-and-rear directions;
a mirror fixed to the mirror mount, the mirror irradiating laser beams by performing reciprocal rotational motion with the mirror mount with respect to the rotation shaft; and
a weight arranged on at least one of a first side and a second side of the mirror mount, the weight being interposed between the rotation shaft and the at least one of the first side and the second side to compensate concentricity of the mirror.

2. The optical module for irradiation of laser beams of claim 1, wherein the weight is arranged on the first side of the mirror mount.

3. The optical module for irradiation of laser beams of claim 1, wherein the weight includes a first weight and a second weight arranged on the first side and the second side, respectively, of the mirror mount, the first weight and the second weight having different weights.

4. The optical module for irradiation of laser beams of claim 1, further comprising bolts fixed onto the first side and the second side, respectively, of the mirror mount, the weight being in a form of nuts fastened to the bolts.

5. The optical module for irradiation of laser beams of claim 4, wherein the weight includes a third weight and a fourth weight arranged on the first side and the second side, respectively, of the mirror mount, the third weight and the fourth weight having different weights.

6. The optical module for irradiation of laser beams of claim 4, wherein the weight includes a third weight and a fourth weight arranged on the first side and the second side, respectively, of the mirror mount, the third weight and the fourth weight having a same weight and being arranged at different distances from the mirror mount.

7. The optical module for irradiation of laser beams of claim 1, wherein the weight is provided in plural along a width direction of the mirror mount along at least one of the first side and the second side of the mirror mount.

8. The optical module for irradiation of laser beams of claim 7, wherein the weight includes a fifth weight and a sixth weight that are arranged at different distances from the mirror, the fifth weight and the sixth weight having different weights.

9. The optical module for irradiation of laser beams of claim 1, wherein the mirror is tilted with respect to an installation direction of the rotation shaft.

10. The optical module for irradiation of laser beams of claim 9, wherein the mirror mount includes:
an inner mount that fixes the mirror and that is tilted with respect to the installation direction of the rotation shaft, and
an outer mount that is coupled to the rotation shaft and the vibration member, the outer mount enclosing sides of the inner mount, which sides exclude a side to which the mirror is fixed.

11. The optical module for irradiation of laser beams of claim 10, wherein the outer mount includes an upper side, the first side and the second side of the mirror mount being a left-side end and a right-side end, respectively, of the upper side.
